(19) United States
(12) Patent Application Publication
(10) Pub. No.: US 2023/0311297 A1
(43) Pub. Date: Oct. 5, 2023

(54) EXOSKELETON DEVICE FOR OUTDOOR ACTIVITIES AND COMPONENTS FOR USE THEREWITH

(71) Applicant: IUVO S.R.L, Pontedera (Pl) (IT)

(72) Inventors: Luca MORELLI, Pontedera (PI) (IT); Matteo MOISE, Pontedera (PI) (IT); Francesco GIOVACCHINI, Pontedera (PI) (IT)

(21) Appl. No.: 18/022,568

(22) PCT Filed: Aug. 23, 2021
(86) PCT No.: PCT/IB2021/057731

§ 371 Date: Feb. 22, 2023

Related U.S. Application Data
(60) Provisional application No. 63/069,985, filed on Aug. 25, 2020.

(51) Int. Cl. B25J 9/00; B25J 9/16; B25J 19/00

(52) U.S. Cl. CPC B25J 9/0006; B25J 9/0009; B25J 9/1633; B25J 19/0075

(57) ABSTRACT

An exoskeleton device for outdoor activities includes means for preventing contamination and damage when used outdoors or in other rugged environments. The exoskeleton device includes a frame, one or more assistive devices, and a sizing component. One or more assistive devices may advantageously comprise components for mitigating the intrusion of and contamination by moisture, dirt, and other contaminants.

### FIELD OF ART

The system relates to passive, assistive exoskeletons arranged to reduce the physical effort of operators, particularly in outdoor or inclement activities, and to components for use therewith.

### BACKGROUND

Exoskeleton devices and body interfaces for the same are an increasingly important field of technology, as exoskeleton devices can help humans conduct various activities in a safer, more efficient, and more comfortable manner. For example, in specific manufacturing settings, workers must conduct physically demanding and precise tasks involving heavy or dangerous objects or awkward or precarious positions, often in a repetitive fashion and for hours at a stretch. Without the assistance of an exoskeleton device, workers may become tired or uncomfortable, leading to errors, low productivity, and possibly even injury. Exoskeleton devices may also enable aging workers with valuable skills and experience to continue to work in a physically demanding field for a more extended period than might be otherwise possible.

Exoskeleton devices are useful for supplementing a human body's natural strength and motions to provide strength, support, and comfort. Exoskeleton devices may have an independent power supply or passive or energy-storage devices, enabling the exoskeleton device to do the “heavy lifting” for a human user through the function of actuators or other motion-assistive components. For example, an exoskeleton device may help a user to hold a heavy tool steadily to focus their attention on using the tool to perform precision or repetitive work.

In other cases, exoskeleton devices may be configured to provide relief when a human user is working in an uncomfortable position or can provide posture improvement. For example, a surgeon may benefit from an exoskeleton device that relieves the surgeon of the effort of holding their arms in a specific position over a patient throughout a surgical operation, or that helps the surgeon to lean over a patient in what would otherwise be an awkward or uncomfortable position for extended periods without fatigue or discomfort. Likewise, a manufacturing technician may benefit from an exoskeleton device holding their arms up or maintaining their posture as they work on a piece of equipment, especially when performing work in an awkward or uncomfortable position, such as standing underneath the piece of equipment.

Other beneficial arrangements include providing additional sets of hands, improved balance, strengthened grip, stabilization of movements, shock absorption, muscle memory, and others.

Exoskeletons may be utilized in various environments, such as on manufacturing floors, in repair shops, or outdoors or in cold environments. For example, an exoskeleton may be used in construction, agricultural, logging, nautical, maintenance, recreational, or other outdoor activities. For example, a user may utilize a passive, assistive exoskeleton to facilitate certain construction-related tasks such as lifting, placing, and holding heavy objects or performing tasks in awkward positions or for uncomfortably long periods. A user may use a passive, assistive exoskeleton in agricultural tasks such as bending or stooping to harvest produce, more safely and precisely cut trees, manipulate heavy objects and equipment on a ship, or perform landscaping-type activities. A user may don an exoskeleton device for performing aircraft maintenance at an airport.

An unaddressed issue in outdoor activities or inclement environments is the risk to a piece of machinery such as an exoskeleton device from contamination, rust, and other environmental damage. Moisture or water may enter a device through gaps between components, resulting in rusting and interference with various operations. Dust or dirt may likewise enter the device through gaps in the device, contaminating, jamming, and otherwise interfering with the proper operation of the device. In exoskeleton devices, exposure of an exoskeleton device during outdoor activities to moisture, dirt, and other contaminants may prevent the actuation devices from properly supporting a user, requiring costly repairs or replacements of the exoskeleton device.

From the preceding, there is a need for an improved exoskeleton device for assisting a user in exerting efforts and specially configured for outdoor activities and other activities where contamination is likely, prolonging the length and quality of the exoskeleton device and reducing damage and the cost of repairs and replacement.

### SUMMARY

According to embodiments of the present disclosure, an exoskeleton device for outdoor activities effectively addresses the problem of exoskeleton devices and other devices being subject to contamination and damage when used outdoors or in other rugged environments. The exoskeleton device for outdoor activities comprises in embodiments a frame, one or more assistive devices, and a sizing component. One or more assistive devices may advantageously comprise components for mitigating the intrusion of and contamination by moisture, dirt, and other contaminants.

In embodiments, the one or more assistive devices may be arranged on the first and second sides of the frame having a sizing component that situates the assistive devices proximate a user's arms and shoulders, as described in U.S. Patent Application Publication No. 2018/0303699, published on Oct. 25, 2018, U.S. patent application Ser. No. 16/750,352, filed Jan. 23, 2020, and U.S. Design Pat. No. 876,654, granted Feb. 25, 2020, each reference belonging to the assignee of the present disclosure and incorporated herein in its entirety by reference.

As described in the above references, the frame and sizing component may comprise a vertical strut configured to extend along a user's back. A horizontal strut extends from a top surface of the vertical strut between a user's shoulders. A sizing component may comprise any suitable mechanism, including a tensioning mechanism, to arrange the assistive devices and associated components about the user's shoulders.

One or more assistive devices may comprise an elastic mechanism arranged to generate a torque proportional to the elevational level, such as a user's arm, as described in International Patent Application Publication No. WO 2019/016629, published on Jan. 24, 2019, belongs to the present disclosure's assignee and is incorporated herein in its entirety by reference.

The elastic mechanism may comprise first and second gear members brought into relative motion about an assisted axis of rotation because of the movement of the user's body, and the elastic mechanism is arranged to impart a moment to the assisted axis of rotation opposite to the resistive movements of the user. The assistive devices may comprise an arm cuff configured to impart assistive forces to a user's arms during activities.

One or more assistive devices may be attached to the frame by one or more hinge mechanisms. A first hinge mechanism may be configured to rotate about a horizontal or anterior/posterior axis to facilitate a predetermined abduction and adduction at the user's shoulder or other movements besides such abduction and adduction. A second hinge mechanism may be configured to rotate about a vertical axis to facilitate a predetermined degree of internal/external rotation of the shoulder or other movements besides such internal/external rotation. One or more assistive devices may pivot about a horizontal axis extending parallel to the frontal plane to facilitate flexion/extension, i.e., raising and lowering the arms.

The exoskeleton device can be configured for outdoor and/or inclement conditions by providing protective components according to embodiments of the disclosure. For example, one or more assistive devices may comprise the elastic mechanism housed within a body or housing. In addition, the body may comprise one or more body components or shells matingly connected along a junction. Whereas in existing devices, such a junction may be imperfectly sealed to the outside during use, allowing contaminants such as water, dirt, or otherwise to enter into the body, the body of the exoskeleton device of the disclosure advantageously comprises one or more protective components configured to seal an interior of the body against an exterior of the body and prevent entrance of contaminants.

In embodiments, the body may comprise two halves joined along a junction. A protective component may extend along a substantial entirety of the junction between the two halves to seal the interior of the body from the exterior and prevent contaminants' entrance. The protective component may be an elastomeric device. In embodiments, the protective component may be a gasket such as an O-ring. The O-ring may define any suitable cross-section, such as a round cross-section, and may be configured to be compressed between the two halves of the body.

In embodiments, one or more surfaces of the exoskeleton device, such as in a body or housing of the one or more assistive devices or the one or more hinge mechanisms, may comprise a plate configured to correspond to an aperture defined in a thickness of the body or housing. In addition, a protective component, such as an elastomeric component, may be custom-fitted to extend at the junction between the plate and the corresponding aperture to similarly seal an interior from an exterior of the exoskeleton device. The protective component may be an O-ring or a V-seal, for example.

In embodiments, one or more components or apertures defined in a surface of a housing or a body of the exoskeleton device may likewise be provided with a protective component. The protective component may be an elastomeric component, such as an O-ring, a V-seal, or a rubber seal. In embodiments, a switch that toggles the exoskeleton device and the one or more assistive devices between a locked and an unlocked configuration may be surrounded by a protective device such that contaminants are barred from entering the body of the assistive device.

The exoskeleton device may further be provided with an improved hinge mechanism. The hinge mechanism may be the first hinge mechanism arranged to facilitate rotation about an anterior/posterior axis to allow abduction and adduction of the shoulder in a predetermined range. The hinge mechanism may be slidingly mounted on a slider truck of the frame to conform to a user's shoulder width properly.

The hinge mechanism may comprise a shaft attached to the slider truck of the frame by a sliding component. The shaft may attach to the slider truck in a sliding and non-rotatable manner or may be directly affixed to the frame. The shaft may comprise an extending portion that defines a bearing surface. A carter or rotating component may be provided and configured to rotate about the bearing surface. The carter may be affixed to or cooperate with a housing or body of the hinge mechanism, whereby the assistive devices located distally of the hinge mechanism may pivot according to the rotation of the hinge mechanism.

The housing of the hinge mechanism may comprise a regulation mechanism, such as a screw, that engages with an aperture defined within the housing of the hinge mechanism. The housing and the regulation screw may be configured such that the regulation screw can adjust an allowed degree of adduction. While the allowed degree of adduction may be any suitable amount, in embodiments the regulation screw limits adduction to between 5 and 20 degrees. In embodiments, the hinge mechanism is configured to allow a passive degree of abduction, which may be but is not limited to 85 degrees. The carter may define a stop-forming surface corresponding to the regulation screw that may abut the regulation screw when the predetermined adduction has been reached to arrest further adduction.

These and other features, aspects, and advantages of the present disclosure will better understand the following description, appended claims, and accompanying drawings.

### BRIEF DESCRIPTION OF THE DRAWINGS

The drawing figures are not necessarily drawn to scale, but instead are drawn to provide a better understanding of the components thereof and are not intended to be limiting in scope but to provide exemplary illustrations. For example, the figures illustrate exemplary configurations of an adapter for a rotary device, and in no way limit the structures or configurations according to the present disclosure.

FIG. 1 is a perspective view of an exoskeleton device according to embodiments of the present disclosure.

FIG. 2A is a perspective view of a lateral side of an assistive device configured for the exoskeleton device of FIG. 1.

FIG. 2B is a perspective view of a medial side of the assistive device of FIG. 2A.

FIG. 3A is a perspective schematic view of a hinge mechanism configured for the exoskeleton of FIG. 1.

FIG. 3B is an elevational view of the hinge mechanism of FIG. 3A.

FIG. 3C is an elevational schematic view of the hinge mechanism of FIG. 3A.

FIG. 4 is a graph showing assistance levels as a function of the shoulder flexion angle of an exoskeleton device according to embodiments of the disclosure.

FIG. 5 is an elevational back view of an exoskeleton device in an unflexed configuration according to embodiments of the disclosure.

FIG. 6A is a graph showing the risk of bumping into objects in the frontal plane according to degrees of flexion and abduction.

FIG. 6B is a graph showing the risk of bumping into objects in the sagittal plane according to degrees of flexion and abduction.

FIG. 6C is a graph showing the risk of bumping into objects in the transverse plane according to degrees of flexion and abduction.

FIG. 7 is an elevational back view of an exoskeleton device in a flexed configuration according to embodiments of the disclosure.

FIG. 8A is a graph showing the risk of entanglement with objects in the frontal plane according to degrees of flexion and abduction.

FIG. 8B is a graph showing the risk of entanglement with objects in the sagittal plane according to degrees of flexion and abduction.

FIG. 8C is a graph showing the risk of entanglement with objects in the transverse plane according to degrees of flexion and abduction.

FIG. 9 is an elevational side view of an exoskeleton device

### DETAILED DESCRIPTION OF VARIOUS EMBODIMENTS

### A. Overview

A better understanding of different embodiments of the disclosure may be had from the following description read with the accompanying drawings in which like reference characters refer to like elements. While the disclosure is susceptible to various modifications and alternative constructions, certain illustrative embodiments are in the drawings and are described below. It should be understood, however, there is no intention to limit the disclosure to the embodiments disclosed, but on the contrary, the intention covers all modifications, alternative constructions, combinations, and equivalents falling within the spirit and scope of the disclosure.

A better understanding of different embodiments of the disclosure may be had from the following description read with the accompanying drawings in which reference characters refer to like elements.

It will be understood that, unless a term is defined to possess a described meaning, there is no intent to limit the meaning of such term, either expressly or indirectly, beyond its plain or ordinary meaning.

### B. Definitions

For ease of understanding the disclosed embodiments of an exoskeleton device and components for use therewith, the interior and exterior portions of the exoskeleton device may be described independently. Interior and exterior portions of the exoskeleton device function together to support a user in exerting efforts.

For further ease of understanding the embodiments of an orthopedic device as disclosed, a description of a few terms, when used, is necessary. As used, the term “proximal” has its ordinary meaning and refers to a location next to or near the point of attachment or origin or a central point or located toward the center of the body. Likewise, the term “distal” has its ordinary meaning and refers to a location situated away from the point of attachment or origin or a central point, or located away from the center of the body.

Medial is toward the midline of the body or the median or mid-sagittal plane, which splits the body, head-to-toe, into two halves, the left and right. Lateral is the side of the body or part of the body that is away from the middle. In the knee, the medial side is on the inside of the exoskeleton device, and the lateral side is on the outside of the device relative to the median plane.

The term “posterior” also has its ordinary meaning and refers to a location behind or at another location's rear. The term “anterior” has its ordinary meaning and refers to a location ahead of or in front of another location.

The term “frontal plane” has its ordinary meaning and refers to a plane extending through a body to divide the body into the front or anterior and back or posterior halves. The term “sagittal plane” has its ordinary meaning and refers to a plane extending through a body to divide the body into left and right halves, as in the mid-sagittal plane referenced above. The term “transverse plane” has its ordinary meaning and refers to a plane extending through a body to divide the body into the top or upper and bottom or lower halves.

### C. Various Embodiments of the Exoskeleton Device and Components for Use Therewith

The exoskeleton device and components for use therewith according to embodiments of the present disclosure advantageously overcome the problem of exoskeleton devices and other devices being vulnerable to contamination, and therefore needing costly repairs and replacements, by providing improved components that shield an interior of the exoskeleton device, including components housed in the interior of the exoskeleton device, from contaminants.

Protective components may be provided to extend at or through a junction between components defining a body of a component, such as one or more assistive devices. Protective components may be formed from elastomers or other polymeric materials as suitable. They may be custom fitted to the unique profiles and shapes of the components of the exoskeleton device.

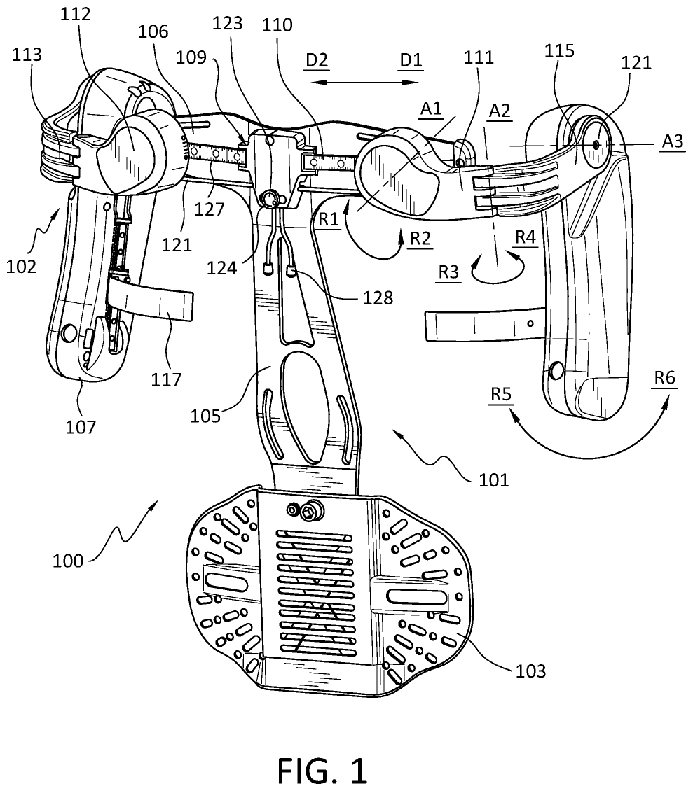

FIG. 1 shows in perspective view an exoskeleton device 100 according to the embodiments. The exoskeleton device 100 may comprise a frame or a frame system 101 and an assistive system 102 comprising one or more assistive devices 107. Each of the assistive devices 107 may correspond to an arm of a user and attach thereto by an arm cuff 117. The frame system 101 may comprise a vertical strut 105 extending proximate a user's back and attaching to the user at a lumbar section 103, as described in at least U.S. Patent Application Publication No. 2018/0303699, published on Oct. 25, 2018, U.S. patent application Ser. No. 16/750,352, filed Jan. 23, 2020, and U.S. Design Pat. No. 876,654, granted Feb. 25, 2020.

The frame system 101 may comprise a width adjustment feature 109 allowing the assistive devices 107 to correspond to the width of a user's shoulders. The width adjustment feature 109 may include a slider truck 110 extending horizontally along a horizontally extending strut 106 of the frame system 101, and allowing the assistive device 107 to be translated in directions D1, D2. The width adjustment feature 109 may include one or more tensioning elements 121, allowing a user to adjust a width of the assistive devices 107. For example, a user may apply increased tension to the one or more tensioning elements 121 to draw the assistive devices 107 in a medial direction D2 or may release a degree of tension to allow the one or more assistive devices 107 to translate in a lateral direction D1, as suitable.

The one or more tensioning elements 121 may be formed of any suitable material. In embodiments, the one or more tensioning elements 121 are formed from an elastomeric material, such as natural or synthetic rubbers, silicone, EPDM, nitrile, neoprene, ethylene propylene diene monomer (EPDM), combinations, thereof, and any other suitable material. The one or more tensioning elements 121 may each correspond to an assistive device 107 and may be provided in substantially symmetric configurations relative to each other for ease and simplicity of use.

An adjustment mechanism 123 provides the desired degree of tension to one or more of the tensioning elements 121. The adjustment mechanism 123 may apply tension to the one or more tensioning elements 121 as described in U.S. patent application Ser. No. 16/750,352, filed Jan. 23, 2020, and incorporated herein in its entirety by reference. The adjustment mechanism 123 may comprise a body through which channels are defined and configured for receiving the one or more tensioning elements 121 into the body. The adjustment mechanism 123 may define a dial 124 arranged for turning in a tensioning direction (in which one or more of the tensioning elements 121 may be tensioned) or in a release direction (in which the tension may be reduced in the one or more tensioning elements 121).

In embodiments, the adjustment mechanism 123 does not utilize a spring or resilient element to apply tension to the one or more tensioning elements 121 or wind the tensioning elements 121 as in a dial-tensioning mechanism. In embodiments, the dial 124 may comprise a screw extending into the body of the adjustment mechanism 123 to clamp or retain the one or more tensioning elements 121 and to prevent movement of the one or more tensioning elements.

A terminal end 128 of the tensioning elements 121 may be pulled to adjust the width of the assistive devices 107 when the dial 124 is loose to move the first hinge mechanism 112 in a medial direction D2. The terminal end 128 may slide outwardly in a lateral direction D1 under the natural bias of the assistive devices 107 as desired. In embodiments, the one or more tensioning elements 121 may be substantially inelastic. The terminal ends 128 of the one or more tensioning elements 121 may drop down from the width adjustment feature 109 as another indicia of a width of the assistive devices 107 and for convenient manipulation of the terminal ends 128.

The slider truck 110 may define indicia 127 that indicate to a user tension in the one or more tensioning elements 121 and/or width of the assistive devices for intuitive and accurate adjustment of the one or more tensioning elements such that the first hinge mechanism 112 aligns substantially incident with a user's shoulder. Such features may be important for off-the-shelf production and use of an exoskeleton device according to the embodiments of the disclosure, and/or in environments where shift workers alternate use of an exoskeleton device. Users on a subsequent shift can easily adjust the width of the exoskeleton device and associated components based on their dimensions.

While a single adjustment mechanism 123 is shown and described, it will be appreciated that the depicted embodiment is merely exemplary, and multiple parallel adjustment mechanisms 123, each corresponding to a respective tensioning element, may be used as deemed suitable.

One or more hinge components 112, 113, 125 may be provided to allow the assistive devices 107 to assist a user in exerting efforts in a plurality of arm and shoulder positions. Each of the one or more hinge components 112, 113, 125 may correspond to an axis of rotation and shoulder motion. The axes of rotation may be substantially orthogonal to one another. For example, a first axis A1 about which the first hinge component 112 is configured to rotate in directions R1, R2 may facilitate abduction and adduction. The first axis A1 may extend horizontally through an anterior/posterior plane.

A second axis A2 may extend vertically through the second hinge 113 and may facilitate rotation horizontally in directions R3, R4 to facilitate internal and external rotation of the shoulder. A third axis A3 may extend horizontally through the third hinge 125 in directions R5, R6 to facilitate the shoulder's extension and flexion (i.e., upward and downward movement). By providing three hinges 112, 113, 125 corresponding to axes A1, A2, A3 substantially orthogonal to each other, the assistive devices 107 may be configured to assist a user exerting effort in a plurality of suitable positions and configurations.

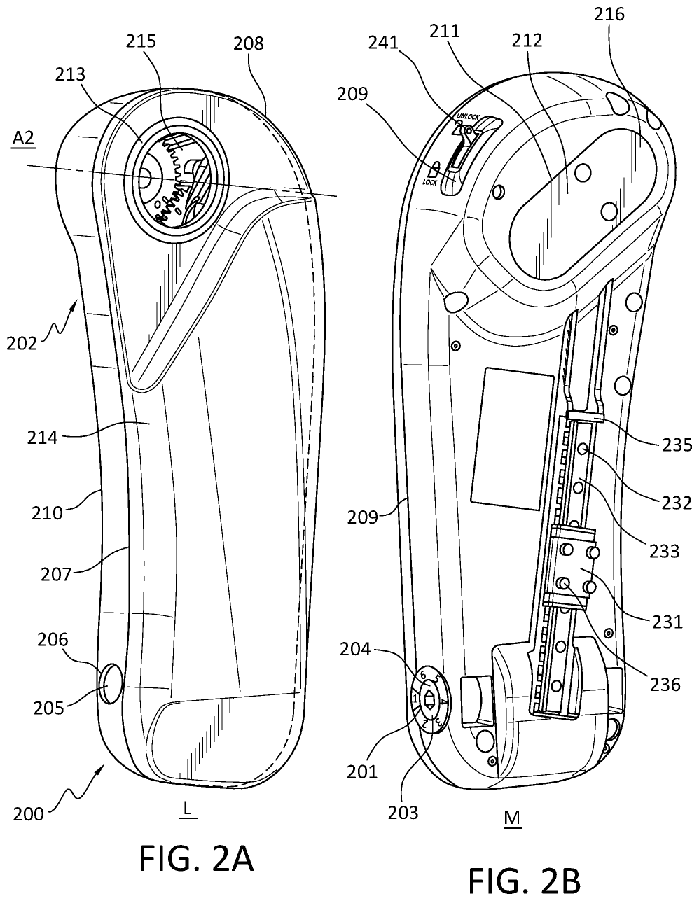

Turning to FIGS. 2A, 2B, the assistive devices 200 according to embodiments of the disclosure may be specially configured for outdoor and/or inclement conditions by providing one or more protective devices shielding components of the assistive devices 200 from contaminants. The assistive device 200 may comprise a housing or body 202. One or more elastic elements or components may be arranged to provide assistive torque to a user, as described in at least International Patent Application Publication No. WO 2019/016629, published on Jan. 24, 2019, and incorporated in its entirety herein by reference.

The assistive device 200 may comprise on a medial side M or surface thereof an arm cuff attachment component 231 and a slider truck 233 defined in embodiments as a railing along which the arm cuff attachment component 231 may translate. The arm cuff attachment component 231 may be any suitable component configured to support an arm cuff (as described in FIG. 1) to transmit forces from the assistive device 200 to a user, such as at the user's upper arm. The arm cuff attachment component 231 may be adjustable relative to the housing 202 of the assistive device 200 with the slider truck 233, extending longitudinally relative to the housing 202.

The arm cuff attachment component 231 may be arranged as a carriage block to translate relative to the slider truck 233 in any suitable manner, such as by using a ball or roller bearings or otherwise. The slider truck 233 and the arm cuff attachment component 231 may be configured to lock movement such that the arm cuff attachment component 231 is arrested or restricted from translating relative to the slider truck 233, for example when a desired position of the arm cuff has been reached. The arm cuff attachment component 231 may comprise one or more fasteners 236 configured to extend through the arm cuffs thickness and secure into the arm cuff attachment component 231.

Movement of the arm cuff attachment component 231 relative to the slider truck 233 may be locked by any suitable mechanism, such as a pin that extends through the slider truck 233, by frictional features that may be locked relative to the slider truck 233, or by any other suitable mechanism. This arrangement may allow the user to conveniently, efficiently, and accurately adjust the position of the arm cuff based on the user's dimensions and needs. Indicia 232 provided on the slider truck 233 may help a user locate the arm cuff attachment component 231 reliably. A maximal degree of the translation may be defined by terminal stop-forming portions 235 at either end of the slider truck 233.

The housing 202 may comprise first and second halves or components 210, 214 that may be releasably attached to define an interior of the assistive device 200 in which the elastic components and other components may be disposed of. The first and second halves 210, 214 may be joined along a junction 207 generally extending longitudinally about the assistive device 200. A protective component 209 may be provided at a substantial entirety of the junction 207.

The protective component 209 may be an O-ring formed from an elastomeric material and custom-fitted to a profile 208 formed and defined by the shape of the housing 202. The elastomeric material may be any suitable elastomer, including polytetrafluoroethylene (PTFE) or another fluorocarbon-based polymer, silicone rubber, neoprene, nitrile, EPDM rubber, or any other suitable material. In embodiments, the O-ring is not formed from an elastomer but from any other suitable material, including other polymeric or synthetic materials.

The housing 202 may further comprise a plate 212 configured to cooperate with an aperture 211 defined through at least part of a thickness of the housing 202. The aperture 211 may be configured to allow access to an internal component, such as the elastic element, for production, maintenance, customization, or replacement. The plate 212 may releasably attach to the housing 202 at the aperture 211 in any suitable manner. The plate 212 may be adhered to using an adhesive, for example, or using a biasing element to tension the plate 212 into the aperture 211.

A protective component 216 is advantageously arranged between the plate 212 and at least a portion of a periphery of the aperture 211. The protective component 216 may be an O-ring formed from an elastomeric material or a V-seal component available from The Timken Company of North Canton, Ohio. For example, the V-seal component may be formed from an elastomeric material such as nitrile or a vinylidene fluoride-based polymer.

While an O-ring or a V-seal are contemplated, the depicted example is merely exemplary, and any suitable protective component may be used. In use, the protective component 216 may advantageously seal at least a portion of a junction between the plate 212 and the aperture 211 such that contaminants exterior to a defined interior of the housing 202 are substantially barred from entrance into the housing 202.

In embodiments, additional features such as a switch 241 may be configured with a protective component 209 to prevent contaminants from the entrance. The switch 241 may perform any suitable function, such as locking the assistive device 200 or engaging the elastic mechanism. The protective component 209 may be arranged as a custom rubber seal 209 formed of any suitable polymeric material and attaching proximate the switch 241.

The switch 241 may engage with the internal components of the assistive device 200 through an aperture (not shown), which may be blocked relative to an exterior of the assistive device 200 by the rubber seal 209, which may have sufficient flexibility to allow toggling or another suitable movement of the switch 241 without compromising the security of the seal. The custom rubber seal 209 may be formed from any suitable material, including elastomeric materials, as described herein.

On a lateral side L of the assistive device 200, an aperture 215 may be defined through at least part of a thickness of the housing 202 and through which the one or more hinge components may cooperate with the assistive device 200 at a hinge or rotating component of the internal components to rotate the assistive device 200 according to the user's movements.

Whereas a large proportion of the aperture 215 may, in use, by filled or occupied by connecting components (not shown) that extend between the assistive device 200 and the one or more hinge components, a protective component 213 may be arranged about at least a portion of a periphery of the aperture 215 to prevent entrance of contaminants. The protective component 213 may be any suitable protective component, such as an O-ring, a V-seal, a rubber seal, or any other component. The protective component 213 may be configured to correspond to a shape and dimension of the periphery of the aperture 215. It will be understood that while O-rings, V-seals, and rubber seals have been shown and described, these descriptions are merely exemplary, and any other component may be used as suitable.

Additional apertures 203, 205 may be defined in one or more other surfaces of the housing 202. For example, the aperture 203 may cooperate with a fastener 204. The fastener 204 may, in embodiments, allow a user or manufacturer to adjust tension in the internal components of the assistive device 200 may adjusting or rotating the fastener 204. In embodiments, the fastener 204 may allow a user to adjust a cam between different levels to adjust assistance.

Between the fastener 204 and the aperture 203, a protective component 201 may extend and be compressed between the fastener 204 and the aperture 203 or periphery of the aperture 203. The protective component 201 may be any suitable component and arranged in any suitable configuration, for example, an O-ring, a V-seal, a rubber seal, a custom-fitted element, an elastomeric component, and/or any other property. Likewise, the aperture 205 may comprise a protective component 206 arranged to fill the aperture 205 and seal the aperture 205 from contaminants.

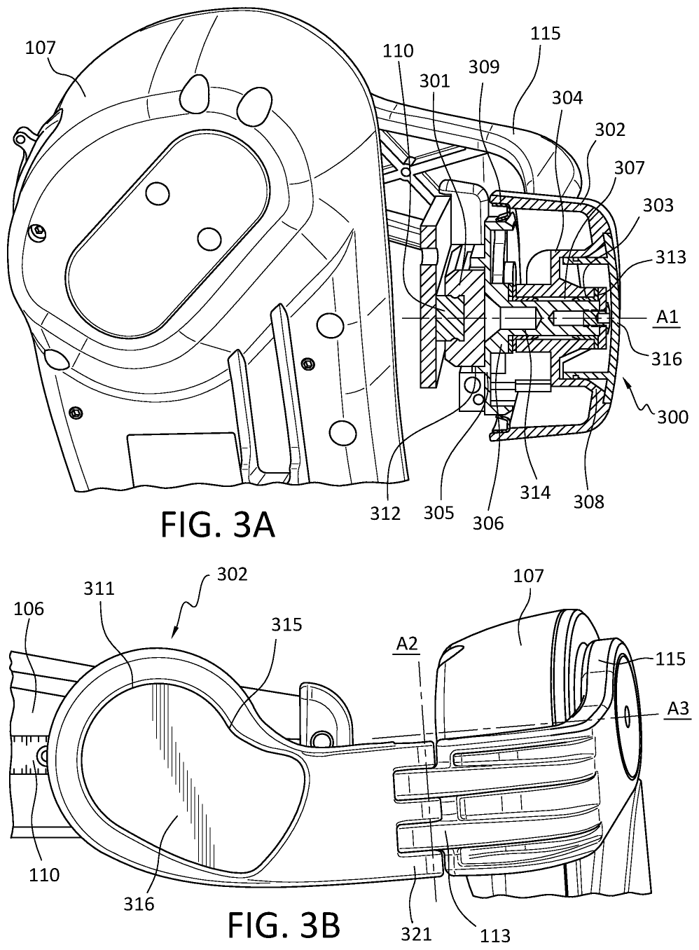

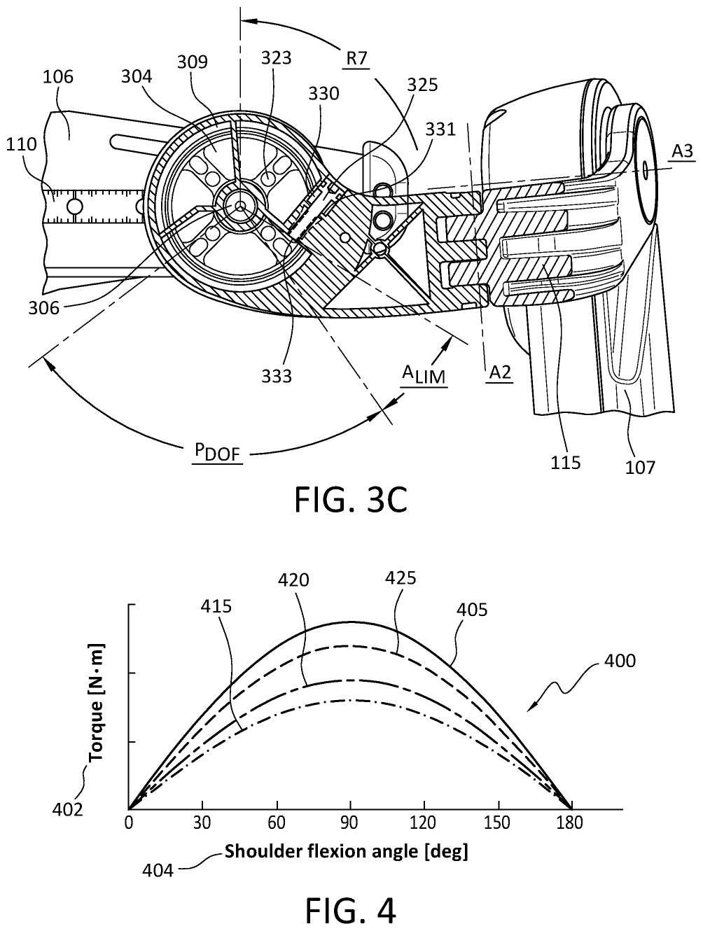

Referring to FIGS. 3A-3C, additional components of an exoskeleton device according to the disclosed embodiments may likewise be modified to be suitable for outdoor and/or inclement environments. A first hinge mechanism 300 is configured to connect an assistive device 107 to a horizontally extending strut 106 of a frame of an exoskeleton device. The first hinge mechanism 300 may be configured to facilitate rotation about an axis A1 extending anteriorly/posteriorly through a horizontal plane to facilitate abduction and adduction of the shoulder.

The first hinge mechanism 300 may comprise a shaft 306 and a carter or rotating member 304 configured to rotate relative to the shaft 306. The shaft 306 may comprise a base plate 305 and an extending portion 314, defining an elongate bearing surface 303. The carter 304 may define an aperture 307 configured to complement and cooperate with the bearing surface 303. Radially extending protrusions 313 on the elongate bearing surface 303 may hold the carter 304 in engagement with the bearing surface 303.

The shaft 306 may attach to the horizontally extending strut 106 of the frame at the slider truck 110 with a carriage block or sliding component 301 that may extend about a top surface and a bottom surface of the slider truck 110 to secure the shaft 306 thereto. In embodiments, the sliding component 301 may translate relative to the slider truck 110 by any suitable means, including ball or roller bearings, a linear rail, or any suitable mechanism.

The sliding component 301 may be fixed to the base plate 305 of the shaft 306 by protrusions 312 extending from the base plate 305 about the top and bottom surfaces of the sliding component 301. Additionally, one or more fasteners 323 may extend through apertures defined through a thickness of the base plate 305 and into the sliding component 301 or other components as suitable for releasably attaching the base plate 305 to the sliding component 301.

The carter 304 may be fixed to a housing 302 of the first hinge mechanism 300 and facilitate rotation of the housing 302 relative to the shaft 306 and the horizontally extending strut 106 of the frame as the user abducts and adducts the shoulder. The housing 302 may be formed of any suitable material, such as synthetic material including polymers or fiber-filled polymers such as carbon fibers, metallic materials including steel or aluminum, or any other suitable material.

A rotary seal 309 may extend circumferentially between the housing 302 and the carter 304 and the shaft 306 about a substantial entirety of a periphery of the hinge mechanism 300 to substantially seal an interior of the hinge mechanism 300 from contaminants such as water, dirt, or other contaminants. The rotary seal 309 may be a WBO single-action rotary shaft seal available from Freudenberg Group of Weinheim, Germany.

For example, the WBO seal 309 may comprise a sealing lip without a spring that provides tight and accurate fitting against a rotating component, such as the carter 304 and the shaft 306. The rotary seal 309 may be formed of any suitable material, including elastomeric material, and may have any suitable configuration. In embodiments, the rotary seal 309 may be configured to facilitate substantially unimpeded rotation of the carter and housing 304, 302 relative to the shaft 306 without allowing the entrance of contaminants.

Additionally, a protective component 308 may be defined between a plate 316 configured to releasably attach at an aperture 315 defined through a thickness of the housing 302. The plate 316 and the aperture 315 may be defined at an outer surface of the hinge mechanism 300 for access by a manufacturer or user to the internal components including the shaft 306 and the carter 304. The protective component 308 may be an O-ring, a V-seal, or any other suitable component and may be specially configured to a profile 311 defined by the housing 302.

The housing 302 may define any suitable shape and may extend continuously laterally relative to the shaft 306 and the carter 304 to define a hinge portion 321 of the hinge 113 at which rotation about a vertical axis A2 allows for internal and external rotation of the shoulder, as described herein.

The hinge mechanism 300 may advantageously be adjustable by a user such that a predetermined or custom adduction and abduction are facilitated. The hinge mechanism 300 may comprise a regulation screw 325 that extends through an aperture 330 defined through a thickness of the housing 302. The regulation screw 325 may extend through a distance 331 of the aperture 330 by a variable amount depending on a desired adduction.

The regulation screw 325 and the aperture 330 may each define corresponding threading or other engagement features. The regulation screw 325 is configured to abut a stop-forming portion 333 of the carter 304 to arrest further rotation. Based on the extension of the regulation screw 325, an adduction limit A_{LIM} may be determined. In embodiments, the distance 331 is configured such that the adduction limit A_{LIM} is controllable to between 5 and 20 degrees of adduction.

The carter 304 may be configured such that a passive degree-of-freedom range P_{DOF} is defined through which abduction in a direction R7 may occur. In embodiments, the passive degree-of-freedom range P_{DOF} may extend a constant 85 degrees. In other embodiments, the degree-of-freedom range may be adjustable by a user or a manufacturer within a certain range, for example, from 0 degrees to 85 degrees, or 25 degrees to 75 degrees. While the disclosed ranges are suggested, it is nonetheless contemplated that the carter 304 and associated components may be configured to provide or allow other ranges as suitable.

FIG. 4 shows a graph 400 depicting assistance levels measured as torque 402 provided by an exoskeleton device according to the disclosure as a function of shoulder flexion angle 404. As seen, various assistance levels 415, 420, 425 are compared against an arm gravity torque level 405. At the assistance levels 415, 420, 425, torque, or assistance provided by the exoskeleton device and the assistive devices may increase from substantially zero to a peak at approximately 90 degrees of shoulder flexion.

Torque may similarly decrease at increasing degrees of shoulder flexion to substantially zero at approximately 180 degrees of shoulder flexion. In the embodiments, torque may follow a substantially symmetrical path from 0 degrees of shoulder flexion to 180 degrees of shoulder flexion, corresponding to the substantially symmetrical degree of gravity torque.

As seen, the assistance levels 415, 420, 425 advantageously may offset different degrees of the gravity torque 405. For example, the assistance level 415 may offset a minimized amount of the gravity torque 405, such as substantially 50%, at 90 degrees of shoulder flexion. The assistance level 420 offsets an increased amount of the gravity torque 405, such as 75%, and whereas the assistance level 425 offsets an increased amount of the gravity torque 405, such as up to 90%. According to the disclosure, the assistive devices of an exoskeleton device may be selected in any suitable manner, such as by a switch, a dial, during manufacturing, or otherwise. While the levels are discussed, it will be appreciated that the disclosed embodiments are merely exemplary, and any manner of assisting may be utilized as suitable.

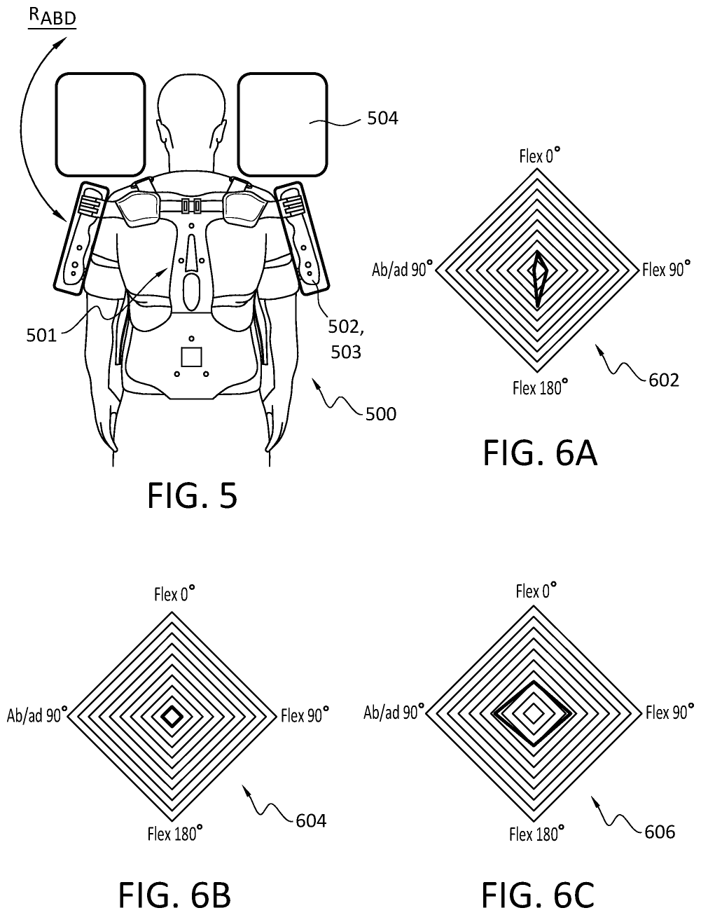

FIG. 5 shows an exoskeleton device 500 according to the disclosure in a back elevational view. According to the above-described embodiments, the exoskeleton device 500 may comprise a frame system 501 and assistive devices 502. An exoskeleton device, according to embodiments of the disclosure advantageously comprises hinge components, and assistive devices configured such that the exoskeleton device 500 does not provide hindrance during the motions enabled by the exoskeleton device 500, and rather all gestures are allowed in the entire range of motion. Because of the absence of passive joints and/or arm modules or assistive devices that extend above the shoulders as in existing exoskeleton devices, the user's range of motion through flexion/extension and abduction/adduction motions is not reduced.

The exoskeleton device 500 assists the user throughout the entirety of a particular movement. For example, an extension may be provided up to 30 degrees, and flexion may be provided up to 180 degrees; however, such limits are merely exemplary and the exoskeleton can be adapted to different limits. The exoskeleton device allows the user to overcome specific limits due to flexibility in coupling the human limbs to the mechanical structure and the contribution of one or more mechanical joints. The exoskeleton device 500 further is configured to follow the physiological shoulder torque profile of the user. In embodiments, the exoskeleton device 500 may permit flexion and extension, i.e., raising or extending the arms upwardly through the sagittal plane and flexing the arms back behind the body, of approximately −55 degrees of extension to approximately 172 degrees of flexion, for a total allowed range of motion of approximately 227 degrees.

In embodiments, the exoskeleton device 500 may permit adduction and abduction through the frontal plane of approximately 1 degree of adduction to approximately 173 degrees of abduction, for a total allowed range of motion of approximately 172 degrees. While the preceding ranges are depicted and described, it will be understood the ranges are merely exemplary, and any suitable range or configuration may be used.

The exoskeleton device 500 may comprise or define a free area 504 about the user's head. The free area 504 advantageously allows for the exoskeleton device 500 to extend and abduct without accidentally bumping into or colliding with the user's head or other objects in a work area, particularly an outdoor work area, such as a construction site, a logging or agricultural site, a fishing vessel, or otherwise. The assistive devices 502 may define a comparatively minor oversize 503. By providing the free areas 504 that are greater, for example, greater than double, the oversize 503 of components of the exoskeleton device 500, the exoskeleton device 500 has a reduced profile that minimizes the risk of accidental collisions.

According to FIGS. 6A-6C, the risk of accidental collisions through each of the frontal, sagittal, and transverse planes of the exoskeleton device 500 is depicted. Accidental collisions may occur in the frontal plane, such as when a user moves forward, such as walking, as depicted in the risk map 602 of FIG. 6A. The exoskeleton device 500 of embodiments have a reduced risk of accidental collision in a 0-degree flex, 90-degree abduction, and 90-degree adduction dimension due to the minimization of protruding parts. While the risk is slightly increased in a 180-degree extension dimension, the risk is less critical due to the likelihood that a user is not walking or moving forward but standing still when the arms are so extended, such as when working underneath an object.

FIG. 6B shows the risk of accidental collisions in the sagittal plane, such as when a user is moving laterally, and considered the most critical for risk-reduction as any posterior protruding parts cannot be seen when so moving. As seen from the risk map 604, the exoskeleton device 500 advantageously reduces risk of accidental collision in each of a 0-degree flex, 180-degree flexion, 90-degree abduction, and 90-degree flexion dimension, due to the low encumbrance of the exoskeleton device 500 and cooperating components, such as the frame 501 and the assistive device 502.

FIG. 6C shows the risk of accidental collisions in the transverse plane, such as when a user moves up or down, which is considered least critical due to the low likelihood of users moving relative to objects in a vertical direction. The exoskeleton device 500 has a comparatively increased but low, risk of an accidental collision through each of a 0-degree flex, 180-degree flexion, 90-degree abduction, and 90-degree flexion dimension compared to movement through the sagittal plane as seen from the risk map 606. Thus, the exoskeleton device 500 advantageously improves the risk management of an exoskeleton device by reducing the risk in the most critical planes.

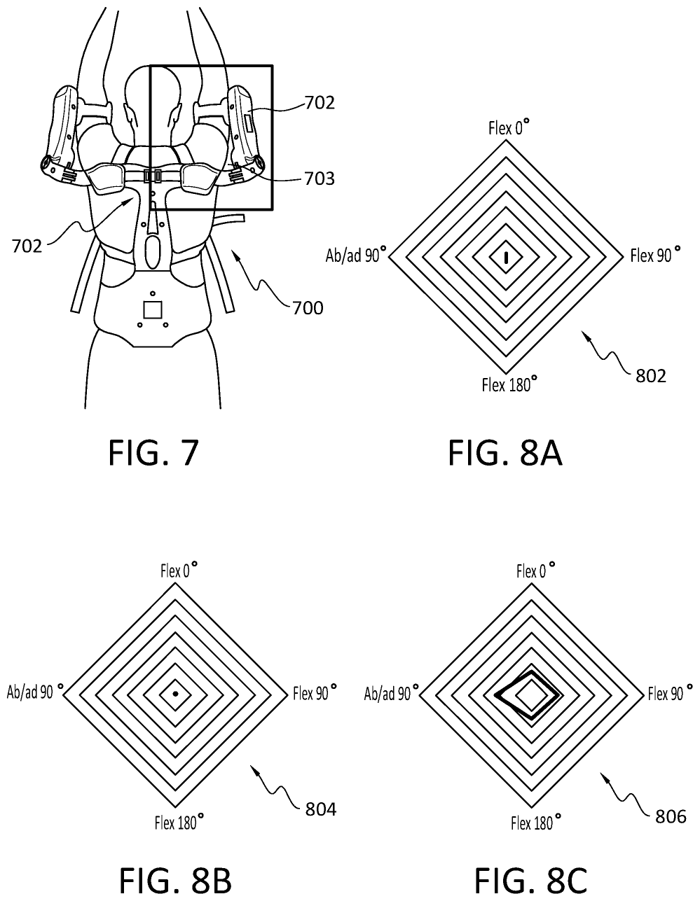

An additional risk mitigated by exoskeleton devices and related components according to embodiments of the disclosure is the risk of entanglement, or the risk of exoskeleton components being entangled, such as due to gaps or holes in or between the exoskeleton and the user, in moving parts of machines, which may pull the user toward moving danger points. As seen from FIGS. 7-8C, an exoskeleton device 700, according to the embodiments, may comprise a frame system 701, assistive devices 702, and gaps 703. The gaps 703 may extend between the assistive devices 702 and the user in various dimensions of flexion/extension or abduction/adduction.

In embodiments, the gaps 703 are minimized by the design of the frame system 701 and the assistive devices 702, as described in the foregoing embodiments, such that the risk of accidental entanglement is mitigated. FIG. 8A shows the risk of accidental entanglement through the frontal plane when a user is moving forward, such as walking. As seen from the risk map 802, because of the minimized profile of the gaps 703 between the assistive devices 702 and the user, the risk of entanglement when walking is minimized in any of a 0-degree flex, 180-degree flexion, 90-degree abduction, or 90-degree flexion dimension.

FIG. 8B shows the risk of accidental entanglement through the sagittal plane when a user is moving laterally, considered the most critical for risk-reduction as any posterior protruding parts cannot be seen when so moving. The risk of accidental entanglement is advantageously minimized, as shown in risk map 804 in any 0-degree flex, 180-degree flexion, 90-degree abduction, or 90-degree adduction dimension due to the configuration of the exoskeleton device 700.

FIG. 8C shows a risk map 806 indicating the risk of accidental entanglement through the transverse plane when a user is moving upward/downward, considered least critical because of the comparative rarity of a user moving vertically relative to objects in the workspace. The gaps 703 provide an increased, but nevertheless low, risk of entanglement in the transverse plane to minimize the risk on both the frontal and sagittal planes.

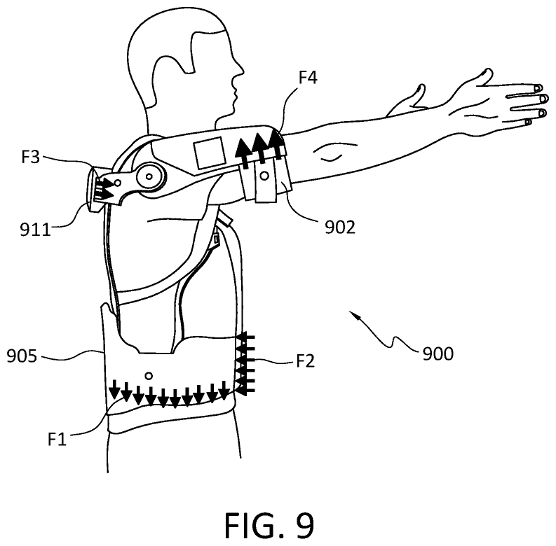

FIG. 9 shows an improved interface between the exoskeleton and a user resulting in improved behavior by the exoskeleton to maintain a tight connection between and the position of the exoskeleton on the user's body during use. This arrangement advantageously reduces the risk of the exoskeleton hindering activities by translating along the user's body, requiring adjustments throughout use, or increasing the risk of malfunctioning of the exoskeleton, accidental collision, or accidental entanglement with objects. An exoskeleton device 900 incorporating features and teachings of the preceding embodiments comprises a frame system including a lumbar support 905, a shoulder supporting component 911 (such as a horizontally extending strut of a frame system), and an arm cuff 902 configured to distribute forces from the exoskeleton device 900 over a large surface area compared to existing exoskeleton devices.

In embodiments, the exoskeleton device 900 may provide a first downward force F1 and a second backwardly extending force F2 distributed by the lumbar support 905 to the user's body. A third forwardly extending force F3 may be distributed by the shoulder supporting component 911, and a fourth upwardly flexion force F4 may be distributed by the arm cuff 902. Because of the increased surface area of the components 905, 911, 902, the exoskeleton device 900 advantageously avoids creating uncomfortable pressure points on the user as it distributes the forces F1, F2, F3, F4.

In embodiments, the exoskeleton device 900 covers up to approximately 37.2% of the front of a user's body, including the front of the user's arms, and up to approximately 56.5% of the back of a user's body, including the back of a user's arms as measured with the arms abducted at 90 degrees. Additionally, the coverage of the front and back of the user's body of the exoskeleton device 900 is better balanced than existing exoskeleton devices, with an approximate 20% difference between the front and back coverage while maximizing the coverage on both. Existing devices may cover more of the front or back of a user's body but have a much larger spread than a 20% difference.

Additionally, components 905, 911, 902 are provided along with the parts of the body where the forces are exerted to distribute the forces best and minimize uncomfortable pressure points and/or ineffective coverage. By providing an exoskeleton device as disclosed with increased and balanced coverage of the user's body, the problem of exoskeletons translating along or poorly cooperating with a user's body is mitigated.

By providing an exoskeleton device and components for use in addition to that according to the disclosed embodiments, the problem of existing devices, including exoskeletons being vulnerable to damage and requiring repair or replacement of components because of contaminants such as water, dirt, dust, or other contaminants is addressed. The exoskeleton device and components for use therewith may advantageously be suited and configured for outdoor or rugged environments, such as construction, agriculture, logging, nautical, and other environments. The exoskeleton device and components for use therewith advantageously comprise improved hinge mechanisms for controlling the desired degree of adduction and abduction.

Further, by providing an exoskeleton device and components for use therewith according to the disclosed embodiments, the exoskeleton device may advantageously provide improved ranges of motion while the configuration of the exoskeleton device reduces a risk of accidental collision with outside objects or entanglement with outside objects during use, improving the safety and longevity of an exoskeleton device according to the embodiments. The distribution of forces from the exoskeleton to the user's body is also improved.

It is to be understood that not necessarily all objects or advantages may be achieved under an embodiment of the disclosure. For example, those skilled in the art will recognize that an exoskeleton device and/or components for use therewith may be embodied or carried out, so it achieves or optimizes one advantage or group of advantages as taught herein without achieving other objects or advantages as taught or suggested herein.

The skilled artisan will recognize the interchangeability of various disclosed features. Besides the variations described, other known equivalents for each feature can be mixed and matched by one of ordinary skill in this art to build and use an exoskeleton device and/or components for use therewith under principles of the present disclosure. It will be understood by the skilled artisan that the features described may be adapted to other methods and types of devices, components, and uses.

Although this disclosure describes certain exemplary embodiments and examples of an exoskeleton device and components for use therewith, it will be understood by those skilled in the art that the present disclosure extends beyond the specifically disclosed components and exoskeleton devices to other alternative embodiments and/or uses of the disclosure and obvious modifications and equivalents thereof, including other types and components of various devices, including orthopedic, prosthetic, medical, and otherwise. It is intended that the present disclosure should not be limited by the disclosed embodiments described above and may be extended to other applications that may employ the features described.

1.-20. (canceled)

21. An exoskeleton device comprising:
a frame arranged for wearing by a user;
at least one assistive device having an elastic mechanism arranged to generate a torque proportional to an elevational level of a user's arm, the elastic mechanism including first and second gear members brought into relative motion about an assisted axis of rotation, and is arranged to impart a moment to the assisted axis of rotation opposite to resistive movements of the user; and
at least one hinge mechanism connecting the at least one assistive device to the frame;
wherein the at least one hinge mechanism comprises:
a shaft; and
a rotating member rotatably connected to the shaft and cooperating with the at least one hinge mechanism such that the at least one assistive device is located distally of the at least one hinge mechanism and pivots according to the rotation of the at least one hinge mechanism.

22. The exoskeleton device of claim 21, wherein the rotating member is fixedly attached to a housing, the housing being hingedly attached to the at least one assistive device.

23. The exoskeleton device of claim 22, wherein the rotating member comprises a protective component arranged about an inner periphery of the rotating member.

24. The exoskeleton device of claim 22, wherein the shaft is translatingly attached to a slider truck of the frame.

25. The exoskeleton device of claim 24, wherein the shaft attaches to the slider truck by a sliding component.

26. The exoskeleton device of claim 25, wherein the shaft comprises one or more protrusions that extend about at least one surface of the sliding component.

27. The exoskeleton device of claim 22, wherein the housing includes a regulation mechanism engaging with a corresponding feature defined within the housing of the at least one hinge mechanism, the housing and the regulation mechanism are configured such that the regulation mechanism is arranged to adjust an allowed degree of adduction.

28. The exoskeleton device of claim 27, wherein the rotating member is configured to permit abduction and/or adduction rotation about a user's shoulder.

29. The exoskeleton device of claim 27, wherein the regulation mechanism is arranged to limit adduction to between 5 and 20 degrees.

30. The exoskeleton device of claim 27, wherein the at least one hinge mechanism is arranged to allow a passive degree of abduction to 85 degrees.

31. The exoskeleton device of claim 21, wherein the shaft includes a base plate and an extending portion defining an elongate bearing surface, the rotating member defining a cooperating feature configured to complement and cooperate with the elongate bearing surface such that radially extending protrusions on the elongate bearing surface are arranged to hold the rotating member in engagement with the bearing surface.

32. The exoskeleton device of claim 21, wherein the shaft attaches to a horizontally extending strut belonging to a frame at a slider truck with a carriage block or sliding component extending about a top surface and a bottom surface of the slider truck to secure the shaft thereto, the sliding component arranged to translate relative to the slider truck.

33. The exoskeleton device of claim 32, wherein the sliding component is arranged to fix to a base plate of the shaft by protrusions extending from the base plate about top and bottom surfaces of the sliding component, at least one or more fasteners extend through apertures defined through a thickness of the base plate and into the sliding component for releasably attaching the base plate to the sliding component.

34. The exoskeleton device of claim 22, wherein a rotary seal is arranged to extend circumferentially between the housing and the rotating member, and the shaft about a substantial entirety of a periphery of the at least one hinge mechanism to substantially seal an interior of the at least one hinge mechanism.

35. The exoskeleton device of claim 21, wherein the at least one assistive device has an elastic mechanism arranged to generate a torque proportional to an elevational level of a user's arm, the elastic mechanism including first and second gear members brought into relative motion about an assisted axis of rotation and is arranged to impart a moment to the assisted axis of rotation opposite to resistive movements of the user.

36. The exoskeleton device of claim 35, wherein the assistive devices include an arm cuff configured to impart assistive forces to a user's arms during activities.

37. An exoskeleton device comprising:
at least one assistive device having an elastic mechanism arranged to generate a torque proportional to an elevational level of a user's arm, the elastic mechanism including first and second gear members brought into relative motion about an assisted axis of rotation, and is arranged to impart a moment to the assisted axis of rotation opposite to resistive movements of the user;
a frame including a vertical strut arranged to extend vertically along a user's spine, and a horizontal strut extending from a top surface of the vertical strut and arranged between a user's shoulders;
at least one hinge mechanism connecting the at least one assistive device to the frame, the at least one hinge mechanism being configured to rotate about a horizontal or anterior/posterior axis to facilitate a predetermined abduction and adduction at a user's shoulder;
wherein the elastic mechanism is housed within a housing including at least two body components or shells matingly connected along a junction along at least one or more protective components is configured to seal an interior of the housing against an exterior of the body and prevent entrance of contaminants.

38. The exoskeleton device of claim 37, wherein the protective component extends along a substantial entirety of the junction between the two body components to seal the interior of the body from the exterior and prevent contaminants' entrance, the protective component may be an elastomeric device.

39. The exoskeleton device of claim 37, wherein the hinge mechanism comprises:
a shaft; and
a rotating member rotatably connected to the shaft and cooperates with the at least one hinge mechanism such that the at least one assistive device is located distally of the at least one hinge mechanism pivots according to the rotation of the at least one hinge mechanism.

40. The exoskeleton device of claim 39, wherein the shaft includes a base plate and an extending portion defining an elongate bearing surface, the rotating member defining a cooperating feature configured to complement and cooperate with the elongate bearing surface such that radially extending protrusions on the elongate bearing surface are arranged to hold the rotating member in engagement with the bearing surface;
wherein the shaft attaches to a horizontally extending strut belonging to a frame at a slider truck with a carriage block or sliding component extending about a top surface and a bottom surface of the slider truck to secure the shaft thereto, the sliding component arranged to translate relative to the slider truck.
